(19) United States
(12) Patent Application Publication
(10) Pub. No.: US 2003/0191687 A1
(43) Pub. Date: Oct. 9, 2003

(54) Automated network marketing system

(76) Inventor: Bernadino J. Pavone, Plymouth, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/117,073

(22) Filed: Apr. 8, 2002

(51) Int. Cl. G06F 17/60

(52) U.S. Cl. 705/14

(57) ABSTRACT

A method of operating a network marketing company in which sales representatives may be recruited using an automated system of communications. In an exemplary optional embodiment, a franchise opportunity may be offered to individuals who would not be otherwise entitled to the franchise opportunity in a traditional network marketing environment.

### CROSS REFERENCE TO RELATED APPLICATION

This application is related to U.S. patent application Ser. No. 10/038,588 filed Jan. 2, 2002, the teachings of which are incorporated herein by reference.

### FIELD OF THE INVENTION

The present invention relates to network marketing systems and, more specifically, to an innovative method of automatically conducting a network marketing business.

### BACKGROUND OF THE INVENTION

Consumers and commercial enterprises buy and sell a vast array of goods and services in the United States each year using network marketing. Based on the proposition that customers are often the best advocates for the products and services they buy, network marketing offers customers of a product the opportunity to sell the products to others and to build networks of others like them.

Firms that sell products and services using network marketing (each a “network marketing company”) typically recruit independent sales representatives. The independent sales representatives then may (but are not required to) recruit others, who may then (but are not required to) recruit still others. For example, using a basic assumption that each of a firm's independent sales representatives recruits three others, and that each of those recruits three others, the firm can have almost a thousand independent sales representatives by the sixth iteration of the process.

Network marketing is a powerful tool that makes use of the personal contacts that almost any potential independent sales representative has simply by virtue of his or her normal social circles. The larger a representative's social circle and the harder the representative is willing to work, the greater the representative's potential to build a successful sales network for the network marketing company.

Network marketing systems are also efficient in that they operate with very little overhead. Each sales representative is an independent operator in a contractual relationship with the network marketing company. Sales representatives usually operate out of their homes and they manage their own inventory and ordering processes. Sales representatives build networks from circles of existing acquaintances and this, although time-intensive, saves the network marketing company the substantial expense of identifying potential sales representatives from among populations of strangers.

So successful has network marketing been in circumventing the traditional brick-and-mortar methods of retail business that network marketing companies are now finding it difficult to use some of the beneficial tools of the traditional retail world they used to eschew.

Some network marketers have integrated more traditional retail operations with person-to-person network-building by allowing representatives who have proven themselves in developing networks to operate from retail storefronts, kiosks, carts or other traditional retail points of sale. That said, every such known prior art organization requires that the representatives who operate traditional retail points of sale first build a sales network from scratch and meet certain minimum requirements as to network depth, breadth, sales volume or some combination of these criteria.

This strategy, though successful, deprives firms of access to a valuable population of potential representatives: those (a) without the personal contacts, time or patience required to develop networks that meet the requirements to open a traditional retail point of sale, but (b) who nevertheless have (i) sales skills and (ii) the necessary capital to invest in such a point of sale.

Traditional retail points of sale are potentially valuable to network marketing companies, but the current business model cannot place those points of sale in the market in less than the time it takes for an independent sales representative to develop a substantial network (if such an independent sales representative is even available in the desired market).

One way to achieve efficiency is to automate the process of making contacts and concluding transactions designed to sell goods and services. However, such techniques have not been efficiently used in a systematic manner to both expand the network and to uncover potential representatives who can operate in traditional retail settings. Modem telemarketers often employ automated calling techniques in order to increase the number of contacts that can be made by a particular marketer in a selling area. These techniques include, among others, the use of autodialers with automated recall and prerecorded messaging. However, these techniques have shortcomings that make it difficult to effectively reach potential network and retail participants. For example, such systems have limited utility because they are not sufficiently versatile to deal effectively with all the various types of systems they can encounter. In addition, conventional automated systems cannot readily accommodate new technologies.

A variety of problems can occur during a routine telemarketing call, which both human operators and automated systems are ill equipped to handle efficiently. Also, automated systems need to be protected from external tampering and provide audible alarms in certain situations. In addition, for legal reasons, it may be necessary to limit the length of a message to an automated system.

Accordingly, it would be desirable to provide an automated method by which a network marketing companies can expand their networks and use traditional retail points of sale in a more effective manner.

It would also be desirable to provide an automated multi-level network marketing system wherein the system is adapted to automatically call contacts from an installed database and to selectively respond to live and automated responses to provide alternative messages or branch to different subroutines for each said respective live and automated responses. Such a system would be capable of simultaneous multi-line operation, automatic redialing and automatic background dialing as other responses are simultaneously handled.

### SUMMARY OF THE INVENTION

In one aspect, the present invention provides a method of network marketing including the steps of choosing a product or service to be sold to consumers; forming a business organization such as a corporation or a limited liability company to market the product or services; contacting potential sales representatives; forming a contractual relationship between the business organization and one or more of the potential sales representatives so contacted, wherein the sales representatives are compensated for selling the product or service on behalf of the business organization and for the sales of the product or service by other representatives directly or indirectly recruited; and automating the process of contacting the potential sales representatives.

In another aspect, the present invention provides a method of network marketing including the steps of choosing a product or service to be sold to consumers; forming a business organization such as a corporation or a limited liability company to market the product or services; contacting potential sales representatives; forming a contractual relationship between the business organization and one or more of the potential sales representatives so contacted, wherein the sales representatives are compensated for selling the product or service on behalf of the business organization and for the sales of the product or service by other representatives directly or indirectly recruited; creating a plurality of levels of compensation for the sales representatives, wherein compensation increases as sales representatives recruit additional sales representatives, directly or indirectly; providing at one of said compensation levels an entitlement for a sales representative to exercise an option to open a franchise retail outlet of said business organization; contacting prospective franchisees, including individuals who are not current sales representatives, and existing sales representatives who have not yet achieved the compensation level required for obtaining a franchise retail outlet, offering the prospective franchisees to make an offer to open a franchise retail outlet in a specific geographic area upon payment of a franchising fee; and automating the process of contacting the potential sales representatives and prospective franchisees.

In an exemplary embodiment, the method includes the step of conditioning the acceptance by the network marketing company of the offer upon a refusal by all existing sales representatives in the specified geographic area to open the franchise retail outlet for a pre-specified fee; offering the availability of the franchise retail outlet to all existing sales representative in the specified geographic area; and granting the franchise to the prospective franchisee only if all existing sales representatives fail to exercise their option to open the franchise retail outlet.

Automating the process of making contact with prospective sales representatives or prospective franchisers includes employing a general purpose computer and a telephone switch programmed to perform specialized calling functions to enable the steps of the process.

### BRIEF DESCRIPTION OF THE DRAWINGS

FIG. 1 is a diagram illustrates a multi-level marketing hierarchy.

FIG. 2 is a diagram which illustrates multiple compensation levels.

FIG. 3 is a flow chart of the method of the present invention.

FIG. 4 is a schematic block diagram of a general purpose computer and telephone switch suitable for performing the method of the invention.

FIG. 5 is a flow chart illustrating a process for recruiting sales representatives and optionally for recruiting prospective franchisees in accordance with exemplary embodiments of the invention.

### DETAILED DESCRIPTION OF THE PREFERRED EMBODIMENTS

In order to provide a better understanding of the present invention, the following terms are defined herein, but such definitions shall not limit the ordinary meaning of these terms:

(a) “downline” means the marketing network of independent sales representative(s) recruited by a given independent sales representative, whether directly (by personally recruiting such independent sales representatives) or indirectly (by having such independent sales representatives recruit still another independent sales representatives, and so on in each iteration).

(b) “network marketing company” means a person that sells goods or services through a network. A network marketing company is part of every independent sales representative's upline and every independent sales representative is part of the network marketing company's downline.

(c) “franchise” means a contract or agreement or other relationship, either express or implied, whether oral or written, between two or more persons to which all of the following apply: (i) a franchisee is granted the right to engage in the business of offering, selling, or distributing goods or services under a marketing plan or system prescribed in substantial part by a franchisor, (ii) a franchisee is granted the right to engage in the business of offering, selling, or distributing goods or services substantially associated with the franchisor's trademark, service mark, trade name, logotype, advertising, or other commercial symbol designating the franchisor or its affiliate, and (iii) the franchisee is required to pay, directly or indirectly, a fee for the rights described in clauses (i) or (ii) above.

(d) “franchisee” means a person who (i) is granted by another the right to engage in the business of offering, selling, or distributing goods or services under a marketing plan or system prescribed in substantial part by that other, who (ii) receives from another the right to engage in the business of offering, selling, or distributing goods or services substantially associated with that other's trademark, service mark, trade name, logotype, advertising, or other commercial symbol designating the other or its affiliate, and who (iii) pays a fee to another for the rights described in clauses (i) or (ii) above.

(e) “franchisor” means a person who (i) grants to another the right to engage in the business of offering, selling, or distributing goods or services under a marketing plan or system prescribed in substantial part by that person, who (ii) grants to another the right to engage in the business of offering, selling, or distributing goods or services substantially associated with that person's trademark, service mark, trade name, logotype, advertising, or other commercial symbol designating that person or its affiliate, and who (iii) receives a fee from another for the rights described in clauses (i) or (ii) above.

(f) “independent sales representative” means a person who sells the products of a network marketing company in a network marketing system in return for compensation. An independent sales representative may, but need not, recruit other persons to be independent sales representatives in the same network. Independent sales representatives are typically independent contractors under state laws.

(g) “network” and “network marketing system” mean a system under which a network marketing company and independent sales representative(s) enter into, and perform under, one or more independent contractor agreements under which independent sales representatives may sell goods and/or services for the networking marketing company to customers and receive commissions from the network marketing company or another person in the independent sales representative's upline; and the independent sales representatives may recruit other persons to be independent sales representative and be compensated based on the sales of the goods and/or services by other independent sales representatives in the independent sales representative's downline.

(h) “person” means an individual, corporation, partnership, limited partnership, limited liability company, association, joint-stock company, trust, an unincorporated organization or other organization.

(i) “retail outlet” means any retail point of sale bearing, or associated with, signage or other indicia disclosing the operator of the point of sale or the products or services sold there and that: (a) is in a fixed location or (b) is associated with a substantial but movable object, which object is usually stationary or is located in one or more particular places for 25% or more of the time it is used for retail sales. For example (and without limitation), a storefront, mall store, stand-alone building, kiosk or cart, would each be a retail outlet. As a further example, neither a motor vehicle nor a recreational vehicle, if either failed to meet the criteria of clause (b) above, would be a retail outlet.

(j) “upline” means the marketing network of independent sales representatives through which a given independent sales representative was recruited.

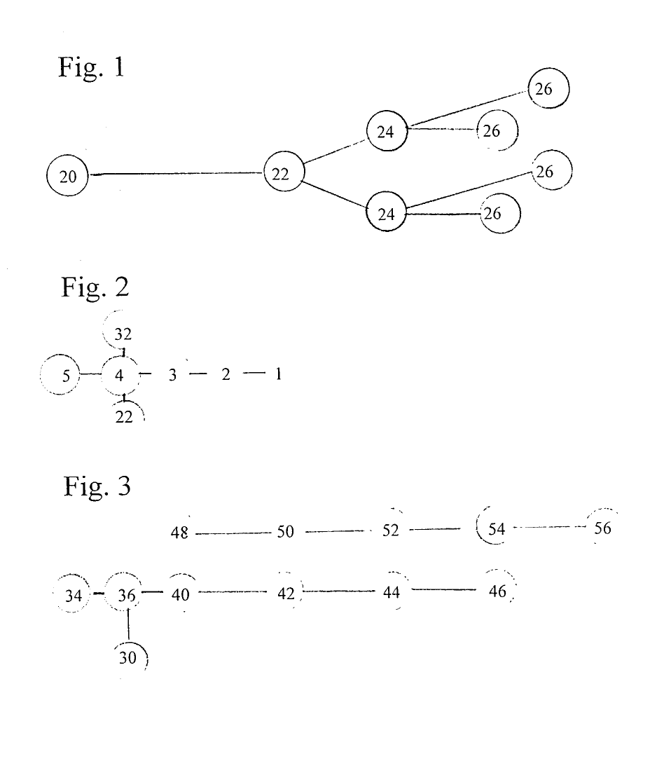

Referring now to FIG. 1 of the drawings, network marketing company 20 is shown. Although network marketing company 20 can be an unincorporated individual, it is preferably a juristic entity such as a corporation or limited liability company. Network marketing company 20 enters into a contractual relationship on an independent contractor (non-employee) basis with independent sales representative 22. This contractual relationship includes provisions providing for payment by the network marketing company of a fee to independent sales representative 22 for each sale of goods or services by independent sales representative 22. The contractual relationship between network marketing company 20 and independent sales representative 22 further provides that independent sales representative 22 will be compensated for sales of goods or services by other independent sales representatives 24 in each independent sales representative's downline and their further downline counterparts 26.

The contractual relationship between independent sales representative 22 and network marketing company 20 may further provide that, based on reaching a preselected sales quota and/or predefined qualities of a downline, independent sales representative 22 moves upward in network marketing organization 28. As shown in FIG. 2 of the drawings, each level (tiers 1-5) provides greater compensation and privileges to independent sales representative 22.

If desired, the system may be expanded to include a franchisee opportunity. For example, in the embodiment illustrated by the solid line at tier 4, independent sales representative 22 may become eligible to open franchise retail outlet 30, most preferably a traditional “brick and mortar” retail store. In addition to reaching tier 4, additional conditions may be imposed on independent sales representative 22 for exercising the option to open franchise retail outlet 30.

Referring still to FIG. 2 of the drawings, a franchisee 32 is shown. Franchisee 32 may be a non-incorporated individual or a juristic entity (e.g., corporation) who is not a current independent sales representative of network marketing company 20, as illustrated by the dotted line. Alternatively, franchisee 32 may be an existing independent sales representative who has not yet reached the franchisee option tier of the network 28.

Referring now to FIG. 3 of the drawings, an exemplary embodiment of the innovative business method of the present invention will be described. In step 34, a prospective franchisee may be identified. The prospective franchisee is not a current independent sales representative of network marketing company 20; that is, the person or juristic entity wishes to become an independent sales representative for network marketing company 20 by opening a franchise retail outlet, for the sale of goods or services of network marketing company 20 and for recruiting additional downstream independent sales representatives to further sell the goods or services of network marketing company 20.

In step 36, the prospective franchisee may be evaluated by network marketing company 20 (franchisor) to determine whether it possesses the qualifications necessary for becoming a franchisee. These qualifications preferably include the ability to purchase the franchise for a predetermined sum; a predetermined credit rating; and some sales experience. Other qualifications may also be imposed. In the event that the prospective franchisee does not possess the necessary qualifications, then the process ends at step 38 and the application by the prospective franchisee is denied.

In the event that the prospective franchisee is qualified, a franchise agreement is negotiated with the prospective franchisee in step 40, which is conditioned upon a refusal by one or more existing independent sales representatives to exercise a franchise option, as will be described more fully hereinafter. In step 42, network marketing company 20, having reached a conditional franchise agreement with the prospective franchisee issues a query for any existing independent sales representative of network marketing company 20 who has a right of first refusal for the franchise opportunity. The query for an existing independent sales representative is limited to those independent sales representatives who are within a preselected geographic area surrounding the general site (preferably a radius of from 10-100 miles from the proposed site) of the proposed franchise as defined in the conditional franchise agreement. In one exemplary embodiment, the query is further limited to that existing independent sales representative who is at the highest level of compensation as determined in FIG. 2 of the drawings.

In the event that either no qualifying existing independent sales representative exists or, in the event that the qualified existing independent sales representative does not wish to exercise the right to open the franchise, then in step 44 the franchise transaction with the prospective franchisee becomes non-conditional and the franchise transaction is completed. In step 46, the franchisee performs under the franchise agreement. The franchise agreement typically includes not only the right to operate a retail outlet on a franchise basis for network marketing company 20, it preferably affords the franchisee all of the benefits afforded independent sales representatives at the franchise entitlement level (tier 4) of the company. That is, if at step 48 a qualified independent sales representative does not wish to exercise the option of first refusal, then the prospective franchisee obtains the franchise.

Referring again to step 48, if a qualified independent sales representative exercises the option to open the franchise (exercises the right of first refusal), in step 50, the prospective franchisee is notified that the franchise is not available. At step 52, the qualified independent sales representative receives the franchise, wherein the franchise agreement is signed at step 44 and the franchise is operated at step 56 by the independent sales representative.

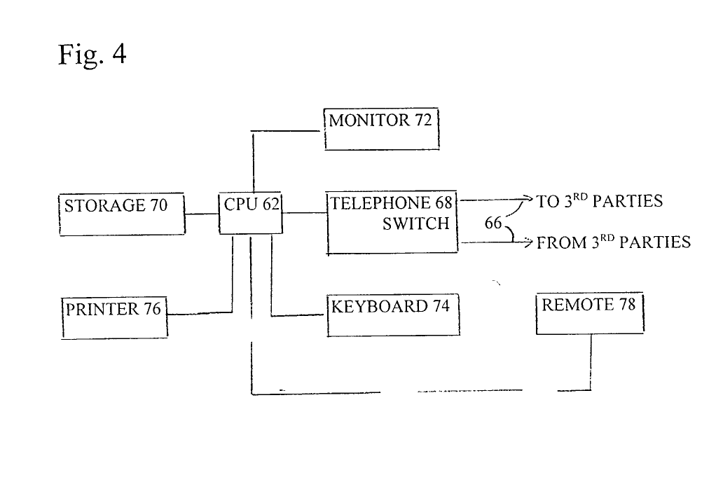

Referring to FIG. 4 there is shown a schematic block diagram of an automated system 60 in the form of a workstation for implementing the method according to the invention. The system 60 includes a central processing unit (CPU) 62 suitably programmed to automatically make and receive telephone calls to parties via appropriate communication links 66 and communication on telephone switch 68. The CPU 62 has a storage device 70, which has storage capacity and memory for storing, among other things, an operating system (O/S), application programs to implement the automated calling; one or more databases, and security features (e.g., firewall). The CPU 62 has a monitor 72, and suitable I/O devices such as a keyboard 74 and a printer 76 configured in a known manner.

It should be clear that the system may be operated by a human operator located at the workstation. Alternatively, the system may be remotely operated at 78 through the link 79 and switch 68.

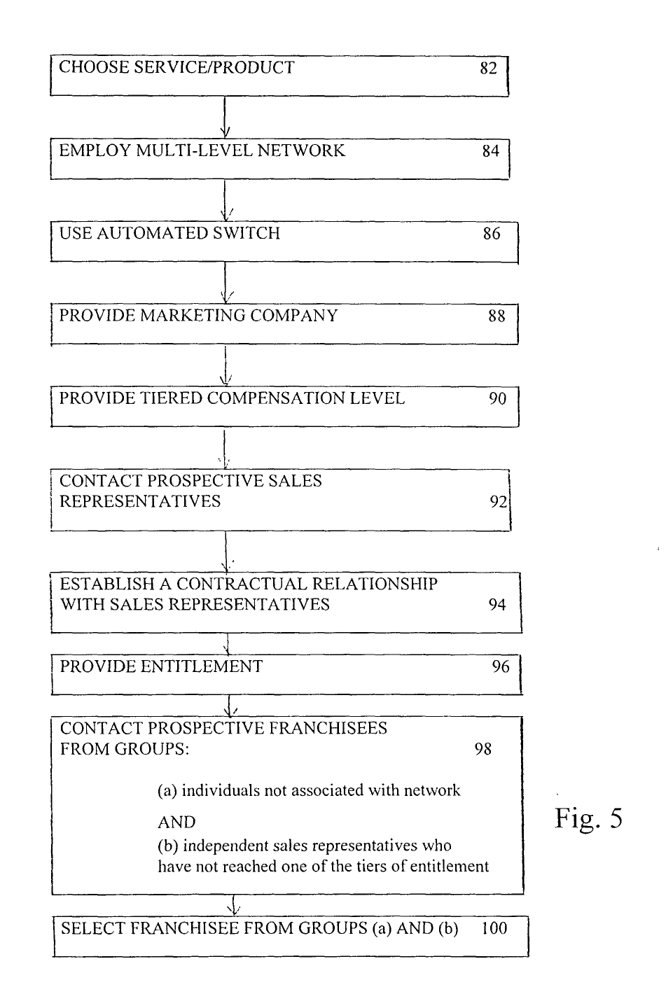

FIG. 5 illustrates a flow chart for implementing exemplary embodiments of the invention. According to the flow chart, a service or product to be marketed is chosen at step 82. This service or product is marketed employing a network 84 using an automated switch 86. In accordance with the invention, the method includes providing a network marketing company 88 as described above. The network marketing company provides a tiered compensation level system 90 for payment of independent sales representatives. The automated switch is used to contact prospective sales representatives at 92, and at step 94, the system is implemented to establish a contractual relation with the prospective sales representatives to in fact establish one or more independent sales representatives for the network.

In addition, the arrangement may include optional steps for adding franchisees. For example, at step 96 the system may provide at least one of said tiers an entitlement for the independent representatives to open a franchise retail outlet for the network marketing company. In addition, the system provides for contacting prospective franchisees using the automated switch at step 98. The prospective franchisees may be (a) individuals not associated with the multi-level network marketing company who do not have an entitlement to open up the franchise retail outlet or (b) independent sales representatives who have not reached one of the tiers of the entitlement. At step 100, a selected franchisee selected from among the prospective franchisees in the previous step. In accordance with the invention, the network may be employed to sell an apparatus or system 60 illustrated in FIG. 5. The system may be implemented to sell services or other goods.

Variations on the invention may be implemented wherein more or fewer restrictions are implemented in order to provide incentives for independent sales representatives and franchisees to expand their respective territories and retail outlets.

An exemplary communications system 60 described in FIG. 4 includes one or more of the following features. The CPU may be a high-end personal computer (PC) such as a Gateway Professional 700 series programmed with the Windows 2000® Professional operating system and Microsoft Office 2000® Small Business Edition, which includes Word 2000®, Excel 2000®, Publisher 2000 ® and Outlook 2000®. The switch 68 may be an ACT 2000® contact manager for small businesses. In an exemplary embodiment, the contact manager or switch 68 can handle up to 4 calls simultaneously in any combination of inbound or outbound links. The communicator 68 may include a storage capability of about 10 GB of voice storage, which may be expanded.

In accordance with the invention, the communicator or switch 68 can store a number of voice- and data-actuated selling campaigns or voice broadcasts to selectable dialing lists. Such a system may be implemented using Microsoft Access® databases which can create customized listings using import list maker. The system may also call directly from the ACT 2000® database. Storage capacity is usually at least 1.5 million telephone numbers.

The switch or communicator 68 has the capability to generate the stored numbers and make calls either sequentially or at random. Stored telephone lists are filtered for zero and low probability prospects, for example, emergency police, hospitals and schools or any party the user does not wish to contact. The system is capable of filtering duplicated numbers and removing the same, as well as numbers that do not fit standard dialing parameters. Additional numbers may be added manually or by using suitable I/O devices.

The communicator 68 Windows 2000® or other dialogue screens for editing and entry of phone numbers. The Microsoft Access® program is capable of controlling the dialing list and manipulating the data. The Microsoft Access® program is well known and requires no special training or proprietary assistance.

The system may further store, maintain and update permanent no-call lists, that is, lists of telephone numbers that the system is not to call.

The system may deliver up to four messages to any list any at any one time.

The system includes calendars to schedule calls and campaigns either immediately at a time or times in the future.

In addition, the communicator may operate the ACT 2000® contact manager and software as another application. Using such software, favorable responses may be automatically imported into the contact manager software including the contact information, and information about the campaign and the response. In addition, voice response may be imported into a notes and history portion of the program.

The entire system may be operated locally or remotely. Contact lists, campaigns, lists, and responses may be manipulated locally and remotely as well. The system is compatible with handheld devices using the Palm® operating system.

In many jurisdictions, dialing lists and calling times are regulated. Accordingly, the system employs application with manual override and failsafe safeguards that limit calls so as to comply with the requirements of law. Suitable caution warnings in the form of screens and alarms are available for assuring that the operator complies with legal restrictions. Such restrictions may be further modified to narrow the scope of dialing times where appropriate.

The communication device 68 also employs e-mail, network browsers, fax and the like using appropriate application programs.

The system further allows the user to create new records or to monitor the flow of information, including voice and data from the workstation.

Because the system employs a sophisticated PC as the control, it is not necessary to use a telephone to monitor responses. The system can, for example, employ Netmeeting® software to monitor the messages.

In addition to the foregoing, the system employs multiple consent options for users or callers to communicate, including entering personal identification numbers to use special promotions. It is also possible to call groups of prospects using conferencing features.

Input and output correspondence may likewise be monitored using a dialing screen monitor to review and differentiate various calls including operator intercepts, answering machines and favorable responses. The operator can also monitor what part of the campaign is playing at a particular time to a particular caller through an audio link. It is also possible to break in or transfer a call to a live operator should the situation warrant such intervention.

As noted above, the system employs Microsoft Access® and a listmaker program to summarize dialing sessions. The system has capability to produce lists, graphs and reports using the Microsoft Excel® program and the information generated by the system. Of course, printers, scanners, uninterruptible power supplies, and other devices may be employed. In addition to operating automatically for a campaign, the system can manage multiple campaigns at different times and to different groups and can manage modem, e-mail and fax schedules as well. The system delivers a message when a phone is answered and can transfer or drop a call when appropriate. The communications device 68, as noted above, is available on the market, is capable of redialing busy numbers any number of programmable number of times, and distinguishing between tape and live voice response. Under such conditions, a live response will prompt a particular campaign or message from the communicator or an automated response will provide an appropriate recorded promotion.

A publication advertising the switch and CPU illustrated in FIG. 4 is incorporated herein by reference. The advertisement qualitatively describes various features of the switch and computer system utilized for implementing the invention. The features are discussed in a way that would be readily understandable to one of ordinary skill in the art. A detailed description of the particulars of the features is therefore not believed to be necessary.

While the foregoing describes exemplary embodiments of the invention, it will be apparent to those of skill in the art that various modifications may be made therein, and it is intended that the accompanying claims cover such modifications as fall within the invention.

1. A method of network marketing comprising the steps of:
choosing a product or service to be sold to consumers;
forming a business organization such as a corporation or a limited liability company to market the product or services;
contacting potential sales representatives;
forming a contractual relationship between the business organization and one or more of the potential sales representatives so contacted on an independent contractor basis, wherein the sales representatives are compensated for selling the product or service on behalf of the business organization and for the sales of additional sales representatives in each sales representative's downline; and
automating the process of contacting the potential sales representatives and prospective franchisees.

2. The method of claim 1 where the steps of:
automating the process of making a contract with prospective sales representatives includes employing a general purpose computer and a telephone switch programmed to perform specialized calling functions to enable the steps the process.

3. The method of claim 1, wherein the specialized calling functions include at least one of:
auto redialing;
click and hang up detection;
open database connectivity;
lines to third party software programs including database software, personal digital assistant programs, Windows CE, Palm OS, and wireless network software;
wireless network connectivity.

4. The method of operating a network marketing company recited in claim 1, wherein said network marketing company sells services.

5. The method of operating a network marketing company recited in claim 1, wherein the network marketing company sells goods.

6. The method of operating a network marketing company recited in claim 1, wherein said productivity is an increase in sales by said independent sales representatives.

7. The method of operating a network marketing company recited in claim 1, wherein said productivity is an increase in recruitment of additional independent sales representatives.

8. The method of operating a network marketing company recited in claim 1, wherein said independent sales representatives are independent contractors.

9. The method of operating a network marketing company recited in claim 1, further including the steps of:
creating a plurality of levels of compensation for the sales representatives, wherein compensation increases as sales representatives build downlines and achieve sales goals;
providing at one of said compensation levels an entitlement for a sales representative to exercise an option to open a franchise retail outlet of said network marketing company; and
contacting one or more prospective franchisees who are not otherwise entitled to open said franchise retail outlet and offering the prospective franchisees the opportunity to open a franchise retail outlet selling the products or services of the network marketing company in a specific geographic area upon payment of a fee.

10. The method according to claim 9, wherein the method includes the steps of:
conditioning the award of the franchise upon a refusal by all existing sales representatives in the specified geographic area to open the franchise retail outlet for a pre-specified fee;
offering the availability of the franchise retail outlet to existing sales representatives in the specified geographic area; and
granting the franchise to the prospective franchisee only if all existing sales representatives refuse the offer of the franchise retail outlet.

11. The method of operating a network marketing company recited in claim 10, wherein said offer of availability of the franchise retail outlet is geographically limited.

12. The method of claim 9, wherein the step of automating the process of making contact with prospective franchisees includes employing a general purpose computer and a telephone switch programmed to perform specialized calling functions to enable the steps of the process.

13. The method of operating a network marketing company recited in claim 9, wherein said one or more prospective franchisees who are not entitled to open said franchise retail outlet are existing independent sales representatives of said network marketing company who have not yet reached said entitled tier of compensation.

12. The method of operating a network marketing company recited in claim 9, wherein said one or more prospective franchisee who are not entitled to open said franchise retail outlet are entities that are not then independent sales representatives of said network marketing company.

14. The method of operating a network marketing company recited in claim 10, further comprising the step of granting said franchise retail outlet to an existing independent sales representative.

15. The method of operating a network marketing company recited in claim 10, further comprising the step of granting said franchise retail outlet to said prospective franchisee who is not otherwise entitled to open said franchise retail outlet.

16. A method of operating a network marketing company with independent sales representatives comprising the steps of:
providing a network marketing company;
providing a tired compensation level system for payment of said independent sales representatives, movement between said tiers being a function of productivity of said independent sales representative; and
automating the process by employing a general purpose computer and a telephone switch programmed to perform specialized calls and functions to enable the steps of the process.

17. The method of operating a network marketing company recited in claim 16, wherein said network marketing company sells services.

18. The method of operating a network marketing company recited in claim 16, wherein the network marketing company sells goods.

19. The method of operating a network marketing company recited in claim 16, wherein said productivity is an increase in sales by said independent sales representatives.

20. The method of operating a network marketing company recited in claim 16, wherein said productivity is an increase in recruitment of additional independent sales representatives.

21. The method of operating a network marketing company recited in claim 16, wherein said independent sales representatives are independent contractors.

22. The method of operating a network marketing company recited in claim 16, further including the steps of:
providing at one of said tiers an entitlement for said independent sales representatives to open a franchise retail outlet of said network marketing company;
offering to one or more prospective franchisees who are not entitled to open said franchise retail outlet an option to open said franchise retail outlet, said option being conditioned upon a refusal by qualified existing independent sales representative to open said franchise retail outlet; and
offering said opportunity to open a franchise retail outlet to said qualified existing independent sales representatives.

23. The method of operating a network marketing company recited in claim 22, wherein said one or more prospective franchisees who are not entitled to open said franchise retail outlet are entities that are not current independent sales representatives of said network marketing company.

24. The method of operating a network marketing company recited in claim 22, wherein said one or more franchisees who do not have an entitlement to open said franchise retail outlet are existing independent sales representatives of said network marketing company who have not yet reached said entitled tier of compensation.

25. The method of operating a network marketing company recited in claim 22, wherein said option is geographically limited.

26. The method of operating a network marketing company recited in claim 22, further comprising the step of granting said franchise retail outlet to said qualified existing independent sales representative.

27. The method of operating a network marketing company recited in claim 22, further comprising the step of granting said franchise retail outlet to said individuals who are not entitled to open said franchise retail outlet under said tiered compensation level system.
